(19) United States
(12) Patent Application Publication
(10) Pub. No.: US 2020/0209094 A1
(43) Pub. Date: Jul. 2, 2020

(54) METHOD AND APPARATUS FOR EXECUTING APPLICATION BY USING BAROMETER

(71) Applicant: Samsung Electronics Co., Ltd., Suwon-si, Gyeonggi-do (KR)

(72) Inventors: Hyun-cheol PARK, Suwon-si (KR); Youl-woong SUNG, Suwon-si (KR); Isak CHOI, Seoul (KR); Hyun-gil CHO, Hanam-si (KR); Sung-hyun HONG, Incheon (KR)

(21) Appl. No.: 16/640,932

(22) PCT Filed: Aug. 21, 2018
(86) PCT No.: PCT/KR2018/009571

§ 371 Date: Feb. 21, 2020

(30) Foreign Application Priority Data
Sep. 29, 2017 (KR) 10-2017-0128312

(51) Int. Cl. G01L 27/00; G01L 7/00; G06F 3/041; H04M 1/725

(52) U.S. Cl. CPC G01L 27/005; H04M 1/72563; G06F 3/0414; G01L 7/00

(57) ABSTRACT

A method and apparatus for executing an application are provided. The method of executing an application may include: measuring internal air pressure in an electronic device by using a barometer; receiving a user input of applying a force to an external surface of the electronic device by using the barometer, and detecting a value of variation of the internal air pressure, the variation occurring due to the force; and performing a preset operation of the electronic device based on the detected value of the variation of the internal air pressure.

### TECHNICAL FIELD

The disclosure relates to a method and apparatus for executing an application by using a barometer, and more particularly, to a method and apparatus for executing an application based on air pressure within an electronic device by using a barometer included in the electronic device.

### BACKGROUND ART

Recently, types of user inputs with respect to an electronic device are diversified. The types of user inputs and units for receiving the user inputs are diversified, the user inputs including a user input directly using a physical button on the electronic device, a user touch input to a display, and a user input using a user movement obtained through a camera.

### DESCRIPTION OF EMBODIMENTS

### Technical Problem

In some embodiments, provided are an electronic device and method of performing a preset operation of the electronic device by using an internal air pressure value varying in the electronic device based on a user input of applying a force to an external surface of the electronic device by using a barometer.

### Solution to Problem

According to a first aspect of the disclosure, provided is an electronic device including: a display; a barometer configured to measure internal air pressure in the electronic device; and a processor configured to receive a user input of applying a force to an external surface of the electronic device by using a barometer, detect a value of variation of the internal air pressure, the variation occurring due to the force, and perform a preset operation of the electronic device based on the detected value of the variation of the internal air pressure.

Also, according to a second aspect of the disclosure, provided is a method of executing an application of an electronic device including a barometer and a display, the method including: measuring the internal air pressure in the electronic device by using the barometer; receiving a user input of applying a force to an external surface of the electronic device by using the barometer, and detecting a value of variation of the internal air pressure, the variation occurring due to the force; and performing a preset operation of the electronic device based on the detected value of the variation of the internal air pressure.

According to a third aspect of the disclosure, provided is a computer-readable recording medium having recorded thereon a program for executing the method of the first aspect on a computer.

### Advantageous Effects of Disclosure

According to an electronic device and method of executing an application according to the disclosure, a preset operation may be performed by using a change in an air pressure, the change occurring due to a user input applied to the electronic device.

### BRIEF DESCRIPTION OF DRAWINGS

FIG. 1 is a block diagram for describing a configuration of an electronic device 1000 according to some embodiments.

FIG. 2 is a block diagram of an electronic device configured to execute an application, according to some embodiments.

FIGS. 3A to 3B are diagrams showing an electronic device configured to execute an application, according to some embodiments.

FIG. 4 is a flowchart of a method of executing an application, according to some embodiments.

FIGS. 5A to 5C is a diagram showing a variation pattern of internal air pressure in an electronic device, according to some embodiments.

FIG. 6 is a diagram showing a graphical user interface which sets a variation pattern of internal air pressure in an electronic device 1000 for determining a type of a user input, according to some embodiments.

FIG. 7 is an execution screen of an application according to some embodiments.

### BEST MODE

According to an embodiment, provided is an electronic device, including: a display, a barometer configured to measure internal air pressure in the electronic device; and a processor configured to receive a user input of applying a force to an external surface of the electronic device by using the barometer, detect a value of variation of the internal air pressure, the variation occurring due to the force, and perform a preset operation of the electronic device based on the detected value of the variation of the internal air pressure.

According to an embodiment, provided is a method of executing an application of an electronic device including a barometer and a display, including: measuring internal air pressure in the electronic device by using the barometer; receiving a user input of applying a force to an external surface of the electronic device by using the barometer, and detecting a value of variation of the internal air pressure, the variation occurring due to the force; and performing a preset operation of the electronic device based on the detected value of the variation of the internal air pressure.

According to an embodiment, provided is a computer-readable recording medium having recorded thereon a program for executing the method of executing the application.

### Mode of Disclosure

Embodiments of the disclosure will now be described more fully with reference to the accompanying drawings to be easily implemented by one of ordinary skill in the art. However, the disclosure may be embodied in many different forms, and should not be construed as being limited to the embodiments set forth herein. In the drawings, parts that are not related to the description are omitted for clear description of the disclosure, and like reference numerals in the drawings denote like elements throughout the specification.

Throughout the specification, it will be further understood that the terms “configured”, “configuring”, “formed”, and/or “forming” and “comprises”, “comprising,”, “includes” and/or “including”, when used herein, specify the presence of stated elements, steps, or operations, but do not preclude the absence of one or more of the elements, the steps, or the operations or the addition of one or more other elements, steps, or operations.

Throughout the specification, while terms “first,” “second,” etc., may be used to describe various elements, such elements must not be limited to the above terms. The terms are used only to distinguish one element from another element.

Throughout the specification, when a region is “connected” to another region, the regions may not only be “directly connected”, but may also be “electrically connected” via another device therebetween. Also, when a part “includes” or “comprises” an element, unless there is a particular description contrary thereto, the part may further include other elements, not excluding the other elements.

Also, throughout the specification, the term “application” may refer to a set of a series of computer programs designed to perform a particular task. The application described in the specification may vary For example, the application may include, but is not limited thereto, a phone book application, a game application, a moving picture reproduction application, a map application, a memo application, a calendar application, a broadcasting application, an exercise support application, a payment application, or a picture folder application.

Also, throughout the specification, a user input may include, but is not limited thereto, at least one of a touch input, a bending input, a voice input, a key input, a multimodal input, and a “pressure input”. The “touch input” indicates a user gesture that is performed on a touch screen so as to control an electronic device. For example, the touch input described in the specification may include a tap, a touch and hold, double-tap, dragging, panning, a flick, a drag and drop, or the like. Also, the term “motion input” indicates a motion that a user does on an electronic device so as to control the electronic device. For example, the motion input may include an input, performed by a user, of rotating the electronic device, tilting the electronic device, or moving the electronic device up and down or left and right. Also, the term “bending input” indicates an input, performed by a user, of bending a whole area or a part of an electronic device so as to control the electronic device when the electronic device is a flexible display device. Also, the term “key input” indicates an input, performed by a user, of controlling an electronic device by using a physical key mounted to the electronic device. Also, the term “multimodal input” indicates a combination of at least two input methods.

For example, an electronic device may receive the touch input and motion input of a user, or may receive the touch input and voice input of a user. Also, an electronic device may receive the touch input and an eye input of a user. The eye input indicates an input by which the user adjusts blinking of an eye, a gaze position, a moving speed of an eye, or the like, so as to control the electronic device.

The term “pressure input” indicates a user input corresponding to a force applied, by a user, to the external surface of an electronic device. For example, pressure input may further include a “squeezing input” in which the user grasps and presses the external surface of the electronic device with a hand, or a “deep touch” in which the user presses the electronic device with a finger for a certain period of time, but is not limited thereto.

The “squeezing input” may include a “double squeezing input” and a “triple squeezing input”, according to the number of times that the user grasps and presses the external surface of the electronic device with the hand.

In some embodiments, the “pressure input” may include a “squeezing and hold” or a “deep touch and hold”, in which the user applies force to the external surface of the electronic device for at least preset time.

Hereinafter, the disclosure will be described in detail with reference to accompanying drawings.

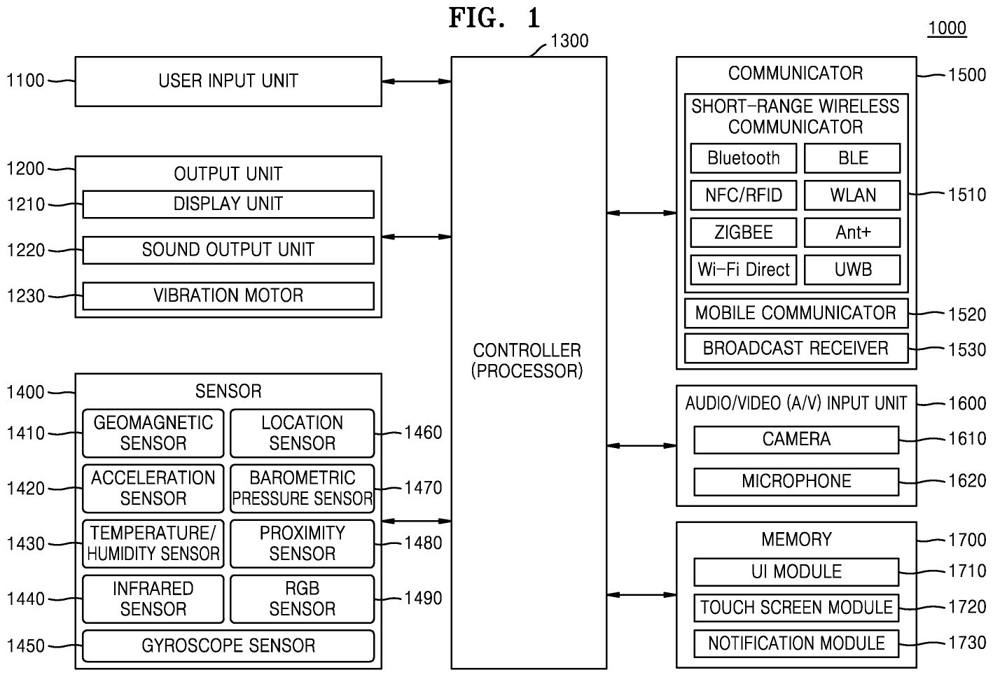

FIG. 1 is a diagram showing an electronic device configured to perform a method of executing an application, according to some embodiments.

FIG. 1 is simply the electronic device according to an embodiment, and the electronic device according to the disclosure may include more or less elements than the elements shown in FIG. 1.

As shown in FIG. 1, an electronic device 1000 according to an embodiment of the disclosure may include a user input unit 1100, a controller 1300, a communicator 1500, an output unit 1200, a sensor 1400, an audio/video (A/V) input unit 1600, and a memory 1700.

Hereinafter, the above-described elements will be sequentially described.

The user input unit 1100 is a unit via which a user may input data for controlling the electronic device 1000. For example, the user input unit 1100 may include a key pad, a dome switch, a touch pad (a touch capacitive type touch pad, a pressure resistive type touch pad, an infrared beam sensing type touch pad, a surface acoustic wave type touch pad, an integral strain gauge type touch pad, a piezoelectric effect type touch pad, or the like), a jog wheel, a jog switch, or the like, but is not limited thereto.

In some embodiments, the user input unit 1100 may include a surface covering the electronic device 1000. To input data for controlling the electronic device 1000, a user may use at least one of all elements of an internal or external surface of the electronic device. For example, the user may use, as the user input unit 1100, a surface surrounding the user input unit 1100, the controller 1300, the communicator 1500, the output unit 1200, the sensor 1400, the A/V input unit 1600, and the memory 1700 of the electronic device 1000.

The internal or external surface of the electronic device 1000 may include a glass material, a metal material, or a flexible material. For example, the internal or external surface of electronic device 1000 may be made up of tempered glass, aluminum, and the like.

The data for controlling the electronic device 1000 may include a pressure value in the electronic device 1000, the pressure value varying due to a force of a user who squeezes the outside of the electronic device 1000 by using a user's hand.

The output unit 1200 is a unit for outputting an audio signal, a video signal, or a vibration signal, and may include a display unit 1210, a sound output unit 1220, a vibration motor 1230, and the like.

The display unit 1210 may display information processed by the electronic device 1000 by the control of the controller 1300 to be described below.

When the display unit 1210 and a touch pad form a layer structure to be configured as a touchscreen, the display unit 1210 may be used as an input device as well as an output device. The display unit 1210 may include at least one of a liquid crystal display, a thin film transistor-liquid crystal display, an organic light-emitting diode display, a flexible display, a three-dimensional (3D) display, and an electrophoretic display. Also, according to an embodiment of the electronic device 1000, the electronic device 1000 may include at least two display units 1210. Here, the at least two display units 1210 may be arranged to face each other by using a hinge.

The sound output unit 1220 outputs audio data, which is received from the communicator 1500 or stored in the memory 1700. The sound output unit 1220 may include a speaker, a buzzer, and the like.

The vibration motor 1230 may output a vibration signal. For example, the vibration motor 1230 may output a vibration signal corresponding to an output of audio data or video data (for example, a call signal reception sound, a message reception sound, or the like). Also, the vibration motor 1230 may output a vibration signal when a touch is input on a touchscreen.

The controller 1300 generally controls overall operations of the electronic device 1000. For example, the controller 1300, by executing programs stored in the memory 1700, may generally control the user input unit 1100, the output unit 1200, the sensor 1400, the communicator 1500, the A/V input unit 1600, and the like.

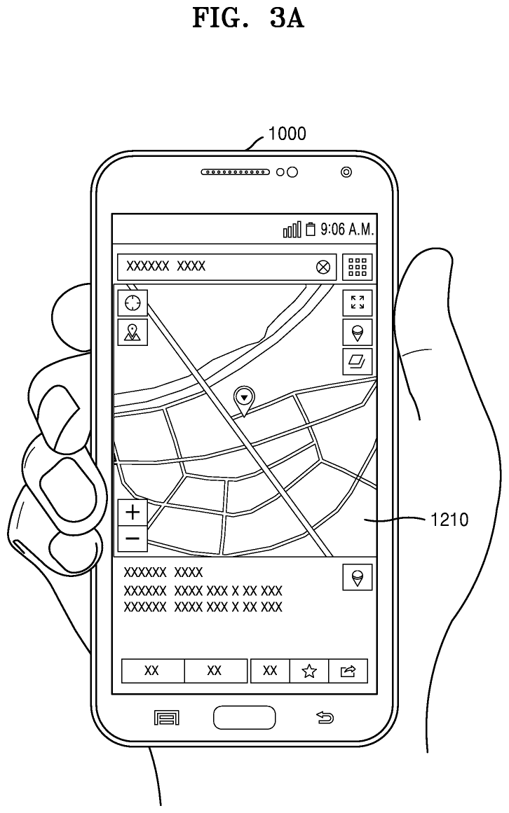

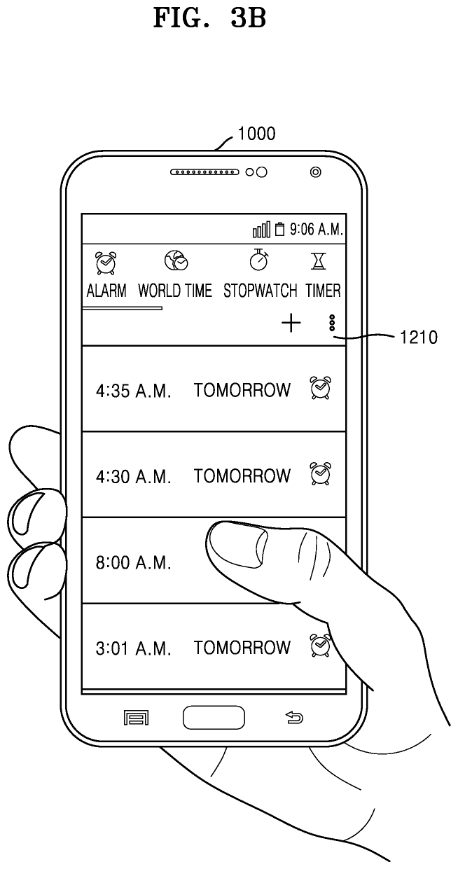

The controller 1300, by controlling the user input unit 1100, the output unit 1200, the sensor 1400, the communicator 1500, and the A/V input unit 1600, may control operations of the electronic device to be described below with reference to FIGS. 3 to 7.

The sensor 1400 may detect states of the electronic device 1000 or states around the electronic device 1000, and may transmit detected information to the controller 1300.

The sensor 1400 may include at least one of a geomagnetic sensor 1410, an acceleration sensor 1420, a temperature/humidity sensor 1430, an infrared sensor 1440, a gyroscope sensor 1450, a location sensor 1460 (for example, a global positioning system (GPS)), a barometric pressure sensor 1470, a proximity sensor 1480, or RGB sensor (or illuminance sensor) 1490, but is not limited thereto.

In some embodiments, the barometric pressure sensor 1470 may measure internal air pressure in the electronic device. In other words, the barometric pressure sensor 1470 may detect a size of internal air pressure in the electronic device by digitizing the internal air pressure in the electronic device, the internal air pressure varying by a force applied from the outside.

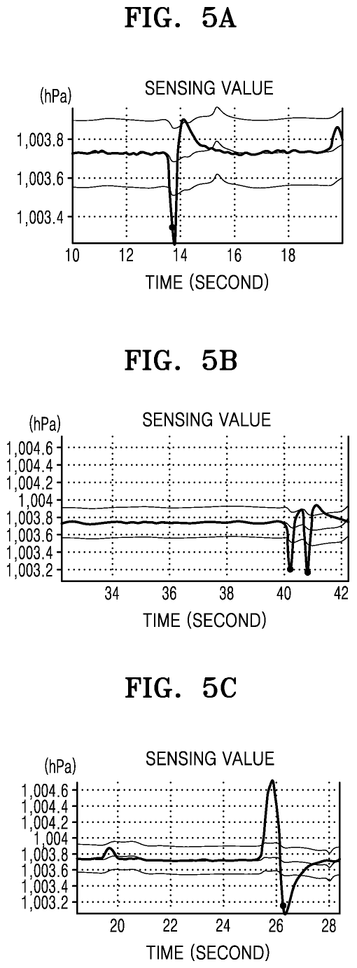

In some embodiments, the size of internal air pressure in the electronic device may vary according to a type of a user input. A pattern of internal air pressure in the electronic device, the pattern varying according to a type of a user input, will be described below with reference to FIG. 5.

In some embodiments, as the inside of the electronic device 1000 is sealed, the barometric pressure sensor 1470 may detect a strength of internal air pressure in the electronic device, the internal air pressure varying by pressure applied from outside.

Throughout the specification, the barometric pressure sensor 1470 may be referred to as a barometer.

Functions of remaining sensors illustrated in the drawings may be intuitively inferred from names of the remaining sensors by a person skilled in the art, and thus, detailed descriptions will be omitted.

The communicator 1500 may include at least one element which allows the electronic device 1000 to communicate with another electronic device or a server (not shown). For example, the communicator 1500 may include a short-range wireless communicator 1510, a mobile communicator 1520, and a broadcast receiver 1530.

The short-range wireless communicator 151 may include a Bluetooth communicator, a Bluetooth Low Energy (BLE) communicator, a near field communicator, a wireless local area network (WLAN) (Wi-Fi) communicator, a ZigBee communicator, an infrared data association (IrDA) communicator, a Wi-Fi direct (WFD) communicator, an ultra wideband (UWB) communicator, or an ANT+communicator, but is not limited thereto.

The mobile communicator 1520 may transmit or receive a wireless signal to or from at least one of a base station, an external terminal, and a server, on a mobile communication network. Here, the wireless signal may include various types of data according to exchange of a voice call signal, an image call signal, or a text/multimedia message.

The broadcast receiver 1530 may receive a broadcast signal and/or information related to a broadcast from an external source through a broadcast channel The broadcast channel may include a satellite channel or a terrestrial channel According to an embodiment, the electronic device 1000 may not include the broadcast receiver 1530.

The communicator 1500 transmits or receives data to or from a different electronic device and server under control of the controller 1300. The communicator 1500 may directly transmit data to the different electronic device or may transmit data through a server. Also, the communicator 1500 may directly receive data from the different electronic device or may receive data through a server.

The AN input unit 1600 is a unit via which an audio signal or a video signal is input and may include a camera 1610 and a microphone 1620. The camera 1610 may obtain a still image or an image frame of a moving image via an image sensor, in a video call mode or a photographing mode. An image captured through the image sensor may be processed by the controller 1300 or a separate image processor (not shown).

The image frame processed by the camera 1610 may be stored in the memory 1700 or may be externally transmitted via the communicator 1500. Two or more cameras 161 may be provided according to a configuration of terminal.

The microphone 1620 receives an external sound signal and processes the external sound signal into electric voice data. For example, the microphone 1620 may receive a sound signal from an external electronic device or a narrator. The microphone 1620 may use various noise removing algorithms for removing noise that occurs while the external sound signal is received.

The memory 1700 may store programs for processes and controls by the controller 1300 and may store input or output data, for example, a plurality of menus, a plurality of first layer sub menus respectively corresponding to the plurality of menus, a plurality of second layer sub menus respectively corresponding to the plurality of first layer sub menus, or the like.

The memory 1700 may include a storage medium of at least one type from among a flash memory type, a hard disk type, a multimedia card micro type, a card type memory (for example, a Secure Digital (SD) or extreme digital (xD) memory), random access memory (RAM), static random access memory (SRAM), read-only memory (ROM), electrically erasable programmable read-only memory (EEPROM), programmable read-only memory (PROM), a magnetic memory, a magnetic disk, or an optical disk. Also, the electronic device 1000 may operate a web storage that performs a storage function of the memory 1700 on the internet, or a cloud server.

Programs stored in the memory 1700 may be classified into a plurality of modules according to functions of the programs, and for example, the programs may be classified into a UI module 1710, a touchscreen module 1720, a notification module 1730, or the like.

The UI module 171 may provide a specialized UI, a GUI, or the like, which is linked to the electronic device 1000 for each application. The touchscreen module 1720 may detect a user's touch gesture on a touchscreen and may transfer information about the touch gesture to the controller 1300. The touchscreen module 1720 according to an embodiment of the disclosure may recognize and analyze a touch code. The touchscreen module 1720 may be separate hardware including a controller (not shown).

Various sensors may be provided in or near a touchscreen in order to detect a touch or proximity touch on the touchscreen. An example of a sensor for detecting the touch on the touchscreen may include a tactile sensor. The tactile sensor indicates a sensor that detects contact of a specific object with a degree or more that is perceivable by a person. The tactile sensor may detect various types of information such as a roughness of a contact surface, a hardness of a contact object, a temperature of a point of a contact, or the like.

The touch gesture of the user may include a tap, a touch and hold, a double tap, dragging, panning, a flick, a drag and drop, a swipe, or the like.

The notification module 1730 may generate a signal for notifying that an event in the electronic device 1000 occurred.

However, not all illustrated elements are essential elements of the disclosure. The electronic device 1000 configured to execute applications may be embodied with more elements than the shown elements, or the electronic device 1000 configured to execute applications may be embodied with fewer elements than the shown elements. For example, in another embodiment of the disclosure, the electronic device 1000 configured to perform applications may or may not include the communicator 1500.

The electronic device 1000 may be a smartphone, a smart TV, a portable phone, a personal digital assistant (PDA), a laptop, a media player, a microserver, a global positioning system (GPS), an e-book reader, a digital broadcasting terminal, a navigation device, a kiosk, an MP3 player, a digital camera, and other mobile or non-mobile computing devices, but is not limited thereto.

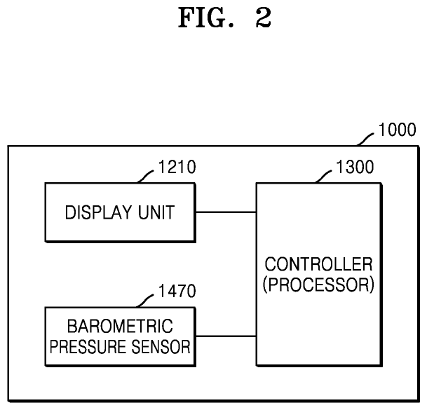

FIG. 2 is a block diagram of the electronic device 1000 configured to execute applications, according to some embodiments.

As shown in FIG. 2, the electronic device 1000 configured to execute applications, according to some embodiments, may include barometric pressure sensor 1470, the display unit 1210, and the controller 1300. However, not all elements illustrated in FIG. 2 are essential elements of the electronic device 1000 configured to perform applications. The electronic device 1000 configured to execute applications may be embodied with more elements than the elements shown in FIG. 2, or the electronic device 1000 configured to execute applications may be embodied with fewer elements than the elements shown in FIG. 2.

The barometric pressure sensor 1470 may measure internal air pressure in the electronic device 1000. In some embodiments, the inside of the electronic device 1000 may be blocked and sealed off from the outside. The barometric pressure sensor 1470 may measure the internal air pressure in the sealed electronic device 1000. In some embodiments, the inside of the electronic device 1000 may include more or less elements than the elements shown in FIG. 1.

An air pressure value of the inside of the electronic device 1000 may be varied as the electronic device 1000 is sealed, according to Pascal's principle.

The controller 1300 may control overall operations of the electronic device 1000. For example, the controller 1300 may generally control, by executing programs stored in a memory of the electronic device 1000, the user input unit 1100, the display unit 1210, controller 1300, the communicator 1500, and the like. The controller 1300 may perform operations of the electronic device 1000 in FIGS. 1 to 7 by executing the programs stored in the memory 1700.

The controller 1300 may detect a value of variation of the internal air pressure in the electronic device 1000, the internal air pressure being measured by the barometric pressure sensor 1470. The controller 1300 may receive a user input of applying a force to the external surface of the electronic device 1000 by using the barometric pressure sensor 1470. The controller 1300 may detect the value of the variation of the internal air pressure in the electronic device 1000, the variation occurring due to the force of the user. The controller 1300 may detect the value of the variation of the internal air pressure in the electronic device 1000 and thus may determine, as the user input, the force a user applies to the external surface of the electronic device 1000.

The controller 1300 may perform a preset operation of the electronic device 1000, based on the detected value of the variation of internal air pressure in the electronic device 1000.

The controller 1300 may determine a variation pattern of the internal air pressure in the electronic device 1000. The controller 1300 may determine a type of the user input, based on the determined variation pattern of the internal air pressure.

The preset operation of the electronic device 1000 may correspond to the type of the user input.

The user input may include a squeezing input in which a user grasps and presses the external surface of the electronic device 1000 with a hand, or may include a deep touch input in which the user presses the display with a finger for a certain period of time.

The “squeezing input” may include a “double squeezing input”, a “triple squeezing input”, and the like according to the number of times that the user grasps and presses the external surface of the electronic device with a hand.

The user input may include a “squeezing and hold” in which a user grasps and presses the external surface of the electronic device with a hand for at least a preset time and a “deep touch and hold” in which a user presses the electronic device for at least a preset time.

In some embodiments, a value of variation of the internal air pressure in the electronic device 1000, the internal air pressure being measured by the barometric pressure sensor 1470, may be extremely small. Accordingly, the controller 1300 may transform, by using an exponential function, the minute value of the variation of the internal air pressure in the electronic device 1000.

The controller 1300 may determine a variation pattern of the internal air pressure in the electronic device 1000 by using the changed value of the variation of the internal air pressure in the electronic device 1000. The controller 1300 may determine the type of the user input based on the variation pattern of the internal air pressure in the electronic device 1000, the variation pattern being determined by using the value of the variation of the internal air pressure in the electronic device 1000.

The controller 1300 may perform a preset operation of the electronic device 1000, based on the changed value of the variation of the internal air pressure in the electronic device 1000.

The display unit 1210 may display an execution screen of an application of the electronic device 1000, the application being executed by the controller 1300.

In some embodiments, the display unit 1210 may display a screen of an application being executed in response to a user input.

In some embodiments, the display unit 1210 may display a graphical user interface in which a variation pattern of the internal air pressure in the electronic device 1000 is set to determine a type of the user input. Also, the display unit 1210 may display a graphical user interface that is necessary for a user to directly set the variation pattern of the internal air pressure in the electronic device 1000, the variation pattern being for determining the type of the user input.

When the display unit 1210 and a touch pad form a layer structure to be configured as a touchscreen, the display unit 1210 may be used as an input device as well as an output device. Also, the electronic device 1000 may include at least two display units 1210.

In some embodiments, the aforementioned operations of the controller 1300, the barometric pressure sensor 1470, and the display unit 1210 may be performed in a locked state of the electronic device 1000.

The electronic device 1000 may perform a preset operation corresponding to a user input in a locked state.

For example, when a squeezing input is the user input and a preset operation corresponding to the squeezing input is an execution of a flashlight application, the electronic device 1000 may release the locked state and may execute the flashlight application.

For example, when a deep touch input is the user input and a preset operation corresponding to the deep touch input is an execution of a music player application, the electronic device 1000 may release the locked state, may execute the music player application, and may play stored music lists.

In some embodiments, the electronic device 1000 may release the locked state only with respect to a preset operation.

FIGS. 3A to 3B are diagrams showing an electronic device 1000 configured to execute an application, according to some embodiments.

FIG. 3A is a diagram showing an embodiment of receiving the “squeezing input” from a user who grasps and presses the external surface of the electronic device 1000.

Referring to FIG. 3A, the user may grab the electronic device 1000 and may apply a certain force to the electronic device 1000, and the barometric pressure sensor 1470 may measure a change in internal air pressure in the electronic device 1000 according to the “squeezing input.”

The controller 1300 may detect a value of variation of the internal air pressure in the electronic device 1000, the internal air pressure being measured by the barometric pressure sensor 1470. The controller 1300 may receive a user input of applying a force to the external surface of the electronic device 1000 by using the barometric pressure sensor 1470.

The controller 1300 may detect the value of the variation of the internal air pressure in the electronic device 1000, the variation occurring due to a force of the user. The controller 1300 may detect the value of the variation of the air pressure in the electronic device 1000 and may determine, as the user input, the force a user applies to the external surface of the electronic device 1000.

The controller 1300 may perform a preset operation of the electronic device 1000, based on the detected value of the variation of the internal air pressure in the electronic device 1000.

The controller 1300 may determine a variation pattern of the internal air pressure in the electronic device 1000. The controller 1300 may determine a type of a user input, based on the determined variation pattern of the internal air pressure.

A preset operation of the electronic device 1000 may be performed according to the type of the user input.

In some embodiments, the preset operation corresponding to a “squeezing input” may execute a map application. In other words, when the “squeezing input” is input to the electronic device 1000, the controller 1300 may display a screen executing the map application on the display unit 1210.

FIG. 3B is a diagram showing an embodiment of receiving a “deep touch input” from a user who presses a part of the display unit 1210 of the electronic device 1000 for a certain period of time.

Referring to FIG. 3B, the user may touch a screen of the electronic device 1000 with a finger and may apply a force to the screen in a bottom direction of the electronic device 1000, and the barometric pressure sensor 1470 may measure a change in the internal air pressure in the electronic device 1000 according to the “deep touch input”.

The controller 1300 may detect a value of variation of the internal air pressure in the electronic device 1000, the internal air pressure being measured by the barometric pressure sensor 1470. The controller 1300 may receive a user input of applying a force to the external surface of the electronic device 1000 by using the barometric pressure sensor 1470.

The controller 1300 may detect the value of the variation of the internal air pressure in the electronic device 1000, the variation occurring due to a force of a user. The controller 1300 may detect the value of the variation of the air pressure in the electronic device 1000 and may determine, as the user input, the force the user applies to the external surface of the electronic device 1000.

The controller 1300 may perform a preset operation of the electronic device 1000, based on the detected value of the variation of the internal air pressure in the electronic device 1000.

The controller 1300 may determine a variation pattern of the internal air pressure in the electronic device 1000. The controller 1300 may determine a type of a user input based on the determined variation pattern of the internal air pressure.

A preset operation of the electronic device 1000 may be performed according to the type of the user input.

In some embodiments, the preset operation corresponding to a “deep touch input” may execute an alarm application.

In some embodiments, the preset operation corresponding to a “deep touch input” may execute a map application. In other words, when the “deep touch input” is input to the electronic device 1000, the controller 1300 may display an execution screen of an alarm application on the display unit 1210.

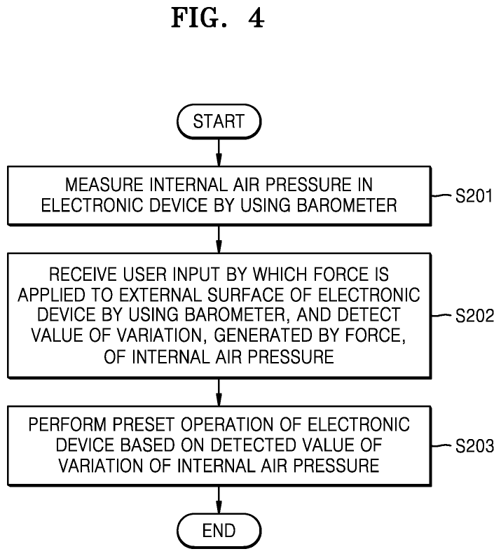

FIG. 4 is a flowchart of a method of executing an application, according to some embodiments.

In operation S201, the electronic device 1000 may measure internal air pressure in the electronic device 1000 by using the barometric pressure sensor 1470.

In some embodiments, the inside of the electronic device 1000 may be blocked and sealed off from the outside. The barometric pressure sensor 1470 may measure the air pressure within the sealed electronic device 1000. Some regions within the electronic device 1000 may be sealed, and the barometric pressure sensor 1470 may detect a change in air pressure of the regions being sealed. In some embodiments, the inside of the electronic device 1000 may include more or less elements than the elements shown in FIG. 1.

The internal air pressure value in the electronic device 1000 may be varied as the electronic device 1000 is sealed, according to Pascal's principle.

In operation S202, the electronic device 1000 may receive a user input of applying a force to the external surface of the electronic device 1000 by using the barometric pressure sensor 1470 and may detect a value of variation of the internal air pressure, the variation occurring due to the force.

The controller 1300 may detect a value of variation of the internal air pressure in the electronic device 1000, the internal air pressure being measured by the barometric pressure sensor 1470. The controller 1300 may receive a user input of applying a force to the external surface of the electronic device 1000 by using the barometric pressure sensor 1470. The controller 1300 may detect the value of the variation of the internal air pressure in the electronic device 1000, the variation occurring due to a force of a user. The controller 1300 may detect the value of the variation of the internal air pressure in the electronic device 1000 and may determine, as the user input, the force the user applies to the external surface of the electronic device 1000.

In some embodiments, the value of the variation of the internal air pressure in the electronic device 1000, the internal air pressure being measured by the barometric pressure sensor 1470, may be extremely small. Accordingly, the controller 1300 may transform, by using an exponential function, the minute value of the variation of the internal air pressure in the electronic device 1000.

The controller 1300 may determine a variation pattern of the internal air pressure in the electronic device 1000 by using the changed value of the variation of the internal air pressure in the electronic device 1000. The controller 1300 may determine a type of a user input based on the variation pattern of the internal air pressure in the electronic device 1000, the variation pattern being determined by using the value of the variation of the internal air pressure in the electronic device 1000.

In operation S203, the electronic device 1000 may perform a preset operation of the electronic device based on the detected value of the variation of the internal air pressure.

The controller 1300 may perform a preset operation of the electronic device 1000 based on the detected value of the variation of the air pressure in the electronic device 1000.

The controller 1300 may determine a variation pattern of the air pressure in the electronic device 1000. The controller 1300 may determine a type of a user input based on the determined variation pattern of the internal air pressure.

A preset operation of the electronic device 1000 may be performed according to a type of a user input.

The user input may include a squeezing input in which a user grabs and presses the external surface of the electronic device 1000 with a hand, or a deep touch input in which the user presses the display with a finger for a certain period of time.

The display unit 1210 may display an execution screen of an application of the electronic device 1000, the application being executed by the controller 1300.

Also, the display unit 1210 may display an application screen being executed by a user input.

In some embodiments, the display unit 1210 may display a graphical user interface which sets a variation pattern of the internal air pressure in the electronic device 1000 for determining a type of the user input. Also, the display unit 1210 may display a graphical user interface that is necessary for a user to directly set the variation pattern of the internal air pressure in the electronic device 1000 for determining the type of the user input.

When the electronic device 1000 receives the pressure input in a locked state, a preset application may be executed while the locked state of the electronic device 1000 is released.

In some embodiments, an application to be executed in the locked state and a certain operation of the application may be preset.

In some embodiments, when the electronic device 1000 receives a pressure input in a locked state and a lock of the electronic device 1000 is released, a camera application is executed as a preset application execution operation and it may be preset to display a camera execution screen on the display unit 1210.

In some embodiments, an operation of executing the camera application may be stored by matching the “squeezing input.”

In some embodiments, when a preset pattern of the squeezing input is received, it may be preset to release a lock of the electronic device 1000. The preset pattern of the squeezing input may be set according to a variation pattern of the internal air pressure in the electronic device 1000 during a time for receiving a plurality of squeezing inputs.

For example, in a locked state of the electronic device 1000, when three squeezing inputs are input to the electronic device 1000 at a first time interval for a certain period of time, the locked state of the electronic device 1000 may be released.

When two squeezing inputs are input to the electronic device 1000 at a second time interval for a certain period of time, the electronic device 1000 may execute a camera application.

For example, in a locked state of the electronic device 1000, when two squeezing inputs are input to the electronic device 1000 at a second time interval for a certain period of time, the electronic device 1000 may execute a camera application.

The first time interval and the second time interval may be the same or may be different from each other.

FIG. 5 is a diagram showing a variation pattern of the air pressure within the electronic device 1000 as a graph, according to some embodiments.

The horizontal axis of the graphs illustrated in FIGS. 5A to 5C is a time axis, and the unit is seconds. The vertical axis of the graphs represents a pressure value, and unit is hectopascal (hPa).

Referring to FIGS. 5A to 5C, when there is no force applied to the electronic device 1000 from the outside, the internal air pressure is fixed to 1,003.8 hPa.

FIG. 5A shows an example of a variation pattern of the internal air pressure in the electronic device 1000 when the electronic device 1000 receives a “squeezing input”.

When the electronic device 1000 receives the “squeezing input”, the internal air pressure in the electronic device 1000 may decrease to a value less than 1,003.4 hPa during the first time interval, and then may increase to 1,003.85 hPa, which is a value higher than the existing air pressure during the second time interval, and finally, may return to the existing air pressure.

FIG. 5B shows an example of a variation pattern of the internal air pressure in the electronic device 1000 when the electronic device 1000 receives a “double squeezing input”.

When the electronic device 1000 receives a “double squeezing input”, at the point in time when a first “squeezing input” is received, the internal air pressure in the electronic device 1000 may decrease to 1,003.2 hPa during the first time interval, and then may increase to 1,003.9 hPa, which is higher than the existing air pressure during the second time interval. Then, at the point in time when a second “squeezing input” is received, the internal air pressure in the electronic device 1000 may decrease to 1,003.2 hPa during a third time interval, and then may increase to 1,004.0 hPa which is a value higher than the existing air pressure during the fourth time interval, and finally, may return to 1,003.8 hPa of the existing air pressure.

FIG. 5C shows an example of a variation pattern of the internal air pressure in the electronic device 1000 when the electronic device 1000 receives a “deep touch input”.

When the electronic device 1000 receives a “deep touch input”, the internal air pressure in the electronic device 1000 may increase to 1,004.6 hPa during the first time interval, and then may decrease to 1,003.2 hPa, which is a value lower than the existing air pressure during the second time interval, and finally, may return to the existing air pressure.

The variation patterns of the internal air pressure in the electronic device 1000 illustrated throughout the specification are merely examples, and the controller 1300 may obtain, from the barometric pressure sensor 1470, a variation pattern of the internal air pressure in the electronic device 1000 according to various pressure inputs.

In some embodiments, the controller 1300 may determine a type of a user input based on a variation pattern of the internal air pressure in the electronic device 1000 according to a received user input.

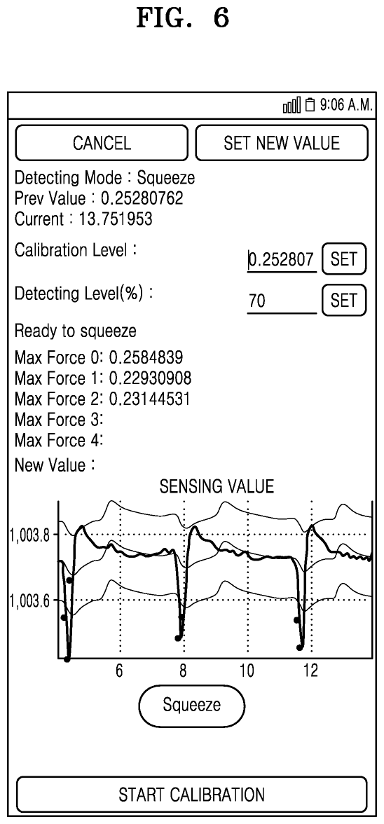

FIG. 6 is a diagram showing a graphical user interface that sets a variation pattern of internal air pressure in the electronic device 1000 for determining a type of a user input, according to some embodiments.

In some embodiments, the display unit 1210 may display a graphical user interface that sets a variation pattern of the internal air pressure in the electronic device 1000 for determining the type of the user input. Also, the display unit 1210 may display a graphical user interface that is necessary for a user to directly set the variation pattern of the internal air pressure in the electronic device 1000 for determining the type of the user input.

In particular, FIG. 6 shows a graphical user interface for a squeezing input that is set by the electronic device 1000. Because a degree of a force a user applies to the external surface of the electronic device 1000 may vary for each user, a personal setting for a pressure input may be necessary.

Referring to FIG. 6, the electronic device 1000 may set a value of variation of the internal air pressure in the electronic device 1000 to 0.25280762, the value being determined by a user input. FIG. 6 illustrates a “calibration level” as a value of variation that is necessary for determining the user input.

When the value of the variation of the internal air pressure reaches, by a user input, to a certain level (i.e., a detection level in FIG. 6) of a “calibration level”, the electronic device 1000 may determine the certain level as the user input. Referring to FIG. 6, when the value of the variation, corresponding to 70% of the “calibration level”, of the internal air pressure is detected, the electronic device 1000 may determine the user input to be the “squeezing input”.

The electronic device 1000 may receive a user input corresponding to a “squeezing input” over a plurality of times, and the “calibration level” and the “detection level” may be set according to a value of variation of the internal air pressure based on the received “squeezing input”.

In some embodiments, each operation for a “squeezing input” set by the electronic device 1000 may be performed by a user.

The display unit 1210 may display a variation pattern of the internal air pressure in the electronic device 1000, the variation pattern being varied based on a user input over time.

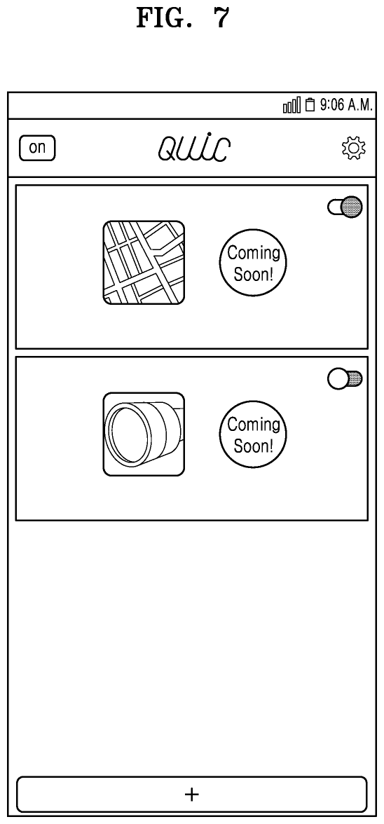

FIG. 7 is an execution screen of an application according to some embodiments.

Referring to FIG. 7, when a user input corresponding to a pressure input is received, the electronic device 1000 may display a screen that sets an application to be executed in response to the user input.

In some embodiments, the electronic device 1000 may set the application to be executed based on at least one of a type of a user input, information about a time that the user input is received, and information about a location of the electronic device.

For example, the electronic device 1000 may set an application to be executed in response to a user input. For example, the electronic device 1000 may execute a map application when a squeezing input is received, and may be set to execute a flashlight application when a double squeezing input is received.

For example, the electronic device 1000 may set an application to be executed, based on the information about the time that the user input is received. For example, the electronic device 1000 may be set to execute a map application when a squeezing input is received during a time between 9 a.m. and 7 p.m., and may be set to execute a flashlight application when a squeezing input is received after 7 p.m.

For example, the electronic device 1000 may set an application to be executed, based on information about a location of the electronic device. For example, the electronic device 1000 may be set to execute a map application in response to a squeezing input when the location of the electronic device 1000 is overseas, and may be set to execute a flashlight application in response to a squeezing input when the location of the electronic device 1000 is domestic.

An embodiment of the disclosure may also be implemented as a recording medium including instructions executable by a computer, such as program modules being executed by a computer. The computer-readable medium may be an arbitrary available medium that can be accessed by a computer and include all of volatile and nonvolatile media and detachable, and non-detachable media. In addition, the computer-readable recording medium may include all of a computer storage medium and a communication medium. The computer storage medium includes all of volatile, nonvolatile, detachable, and non-detachable media implemented using an arbitrary method or technology for storing information such as computer-readable instructions, data structures, program modules, or other data. The communication medium typically includes computer-readable instructions, data structures, program modules, other data as modulated data signals such as carrier signals, or other transmission mechanism, and includes other information transmission media.

The aforementioned descriptions of the disclosure are provided for the purpose of illustration, and it will be understood by one of ordinary skill in the art that various changes and modifications may be made without departing from the spirit or essential characteristics of the disclosure. It is therefore to be understood that the above-described embodiments should be considered in a descriptive sense only and not for purposes of limitation. For example, each component described as a single entity may be distributed and implemented, and components described as being distributed may also be implemented in a combined manner.

The scope of the disclosure is defined by the appended claims rather than by the detailed description and all changes or modifications derived from the meaning and scope of the claims and their equivalents should be construed as being included within the scope of the disclosure.

1. An electronic device comprising:
a display;
a barometer configured to measure internal air pressure in the electronic device; and
a processor configured to:
receive a user input of applying a force to an external surface of the electronic device by using the barometer,
detect a value of variation of the internal air pressure, the variation occurring due to the force, and
perform a preset operation of the electronic device, based on the detected value of the variation of the internal air pressure.

2. The electronic device of claim 1, wherein the processor is configured to detect a transformed value by using an exponential function on the detected value of the variation of the internal air pressure.

3. The electronic device of claim 1, wherein the processor is configured to determine a variation pattern of the internal air pressure varying due to the user input, and determine a type of the user input based on the variation pattern of the internal air pressure, and
wherein the preset operation of the electronic device corresponds to the determined type of the user input.

4. The electronic device of claim 1, wherein the user input comprises at least one of a first input in which the user grabs and presses the external surface of the electronic device with a hand, and a second input in which the user presses a display with a finger for a certain period of time.

5. The electronic device of claim 1, wherein an inside of the electronic device is sealed such that an internal air pressure value of the electronic device varies according to Pascal's principle.

6. The electronic device of claim 3, wherein the variation pattern of the internal air pressure comprises at least one of a first time interval in which the internal air pressure value of the electronic device decreases, and a second time interval in which the internal air pressure value of the electronic device increases.

7. The electronic device of claim 1, wherein, when the electronic device is in a locked state, the electronic device is configured to receive the user input and detect the value of the variation of the internal air pressure, the variation occurring due to the user input, and
wherein the preset operation involves releasing a lock of the electronic device and executing a preset application corresponding to the user input.

8. A method of executing an application of an electronic device comprising a barometer and a display, the method comprising:
measuring an internal air pressure in the electronic device by using the barometer;
receiving a user input of applying a force to the external surface of the electronic device by using the barometer, and detecting a value of variation of the internal air pressure, the variation occurring due to the force; and
performing a preset operation of the electronic device based on the detected value of the variation of the internal air pressure.

9. The method of claim 8, further comprising transforming the detected value of the variation of the internal air pressure by using an exponential function.

10. The method of claim 8, further comprising:
determining a variation pattern of the internal air pressure, the variation pattern varying due to the user input; and
determining a type of the user input, based on the variation pattern of the internal air pressure, and
wherein the preset operation of the electronic device corresponds to the type of the user input.

11. The method of claim 8, wherein the user input comprises at least one of a first input in which the user grabs and presses the external surface of the electronic device with a hand, and a second input in which the user presses a display with a finger for a certain period of time.

12. The method of claim 8, wherein the inside of the electronic device is sealed, and thus an internal air pressure value of the electronic device varies according to Pascal's principle.

13. The method of claim 10, wherein the variation pattern of the internal air pressure comprises at least one of a first time interval in which the internal air pressure value of the electronic device decreases, and a second time interval in which the internal air pressure value of the electronic device increases.

14. The method of claim 8, further comprising, when the electronic device is in a locked state, receiving the user input and detecting the value of the variation of the internal air pressure, the variation occurring due to the user input, and
wherein the performing the preset operation involves releasing a lock of the electronic device and executing a preset application corresponding to the user input.

15. A computer-readable recording medium having recorded thereon a program for executing the method of claim 1 on a computer.
